(19) United States
(12) Patent Application Publication
(10) Pub. No.: US 2008/0059459 A1
(43) Pub. Date: Mar. 6, 2008

(54) System and method for providing focused search term results

(76) Inventor: Robert V. Byron, Plano, TX (US)

Correspondence Address: JACKSON WALKER LLP, 901 MAIN STREET, SUITE 6000, DALLAS, TX, 75202-3797, US

(21) Appl. No.: 11/899,527

(22) Filed: Sep. 6, 2007

Related U.S. Application Data
(60) Provisional application No. 60/842,606, filed on Sep. 6, 2006.

(51) Int. Cl. G06F 17/30

(52) U.S. Cl. 707/5; 707/E17.014

(57) ABSTRACT

A system and method for providing focused search term results is provided. The present invention enables a quick and efficient search without having to search more Internet content than necessary for desired information. A user is able to include selected websites, web pages or classifications in a repository to create a limited search universe. The content of the repository can be dynamic in that the search universe may be changed based on the needs or interests of the user.

### PRIORITY CLAIM

This application claims priority of U.S. Provisional Patent Application Ser. No. 60/842,606, entitled “FOCUSED INTERNET SEARCH SYSTEM AND METHOD” filed Sep. 6, 2006, the teachings of which are incorporated herein by reference.

### FIELD OF THE INVENTION

The present invention is generally related to a search tool, and more specifically to a search tool usable with a social networking site.

### BACKGROUND OF THE INVENTION

Many social networking websites are built around a commonality of interests. Those using social networking websites are not only interested in communicating with others having like interests but obtaining additional information about the shared interest.

Using the search engines presently available, those with a focused interest must search the entire internet when information is sought about a particular area. Such searching method is inefficient and typically results in a large number of “hits”. Many simply do not have the time to wade through the large number of “hits” to find the particular information sought.

To assist those who are unwilling to wade through a large number of “hits” to find the information being sought, there are several prior art programs available which will map the search results according to various criteria. Unfortunately, such prior art programs typically narrow search terms, add additional search terms, or refocus the search request into another area. Some prior art searches display complex and confusing maps of search results which may actually lead a searcher away from the information needed.

### SUMMARY OF INVENTION

The present invention achieves technical advantages as a System and Method for Providing Focused Search Term Results. One embodiment of the invention enables a quick and efficient search without having to search more Internet content than necessary for desired information.

According to the present invention, a user is able to include selected websites, web pages or classifications in a repository to create a limited search universe. The content of the repository can be dynamic in that the search universe may be changed based on the needs or interests of the user.

When an icon appears on a screen for the limited search universe, the user simply selects the icon and begins the search. The search results will be those obtained from only the limited search universe.

For example, if a user wants to search for information about the JAVA programming language, a user could begin by building a list of useful websites and web pages based on prior knowledge that the user believes might be particularly helpful in obtaining the desired information about the JAVA programming language. In addition, there may be a community of users that exists which may also desire access to the list of useful websites and web pages.

Alternatively, the changes to the content of the limited search universe could be automated so that periodically a new search could be done for new information posted to the internet about the JAVA programming language and that information could be added to the limited search universe.

According to the present invention, the user begins by creating a list of searchable terms and saves the list as a search list in a data base. Next the user selects certain search results in terms of URLs, web pages, and websites from the resulting search and saves them in a database as a list for recurring searches. As searches are done, the search results may be saved to refine the search list.

Those of ordinary skill in the art will understand that search resources will include any medium that can be digitized and may include chat rooms, blogs, forums, video, audio, news, images, etc.

When the user selects either the name of the search or the icon to activate the search, the user is prompted for and supplies the desired search terms. The search results come from the limited universe of searchable URLs, web pages, websites within the limited universe.

Over time the user is able, using the search terms, to perform an automatic update of the list of searchable materials that adds URLs, web pages and websites to the list of searchable sites depending on the search results obtained. If additional URLs, web pages and websites are found they may be added either automatically or manually to the universe of searchable information. If URLs, web pages, websites or other searchable material is found to be unreliable or untrustworthy such, URL, webpage, website or other searchable material may be excluded from the universe of searchable material.

If others are allowed to share the effort of creating the focused searchable universe of the present invention, the creator of the universe may pass along rights to those sharing the ability to use the focused searchable universe to make additions or deletions to the content of the searchable universe.

### BRIEF DESCRIPTION OF THE DRAWINGS

FIG. 1 is a diagram of a method for focusing a web-based search, in accordance with an exemplary embodiment of the present invention;

FIG. 2 is a diagram of a method for including or omitting searchable material in accordance with an exemplary embodiment of the present invention; and

FIG. 3 is a diagram of a system for focusing a web-based search in accordance with an exemplary embodiment of the present invention.

### DETAILED DESCRIPTION OF THE PRESENT INVENTION

The focused search system and method of the present invention enables a quick and efficient search without having to search the entire internet for desired information.

According to the present invention, a user is able to include selected websites, web pages or classifications in a repository to create a limited search universe. The content of the repository may he dynamic in that the search universe may be changed based on the needs or interests of the user.

When an icon appears on a screen for the limited search universe, the user simply selects the icon and begins the search. The search results will be those obtained from only the limited search universe.

For example, if a user wants to search for information about the JAVA programming language, a user could begin by building a list of useful websites and web pages based on prior knowledge that the user believes might be particularly helpful in obtaining the desired information about the JAVA programming language. In addition, there may be a community of users that exists which may also desire access to the list of useful websites and web pages.

Alternatively, the changes to the content of the limited search universe could be automated so that periodically a new search could be done for new information posted to the internet about the JAVA programming language and that information could be added to the limited search universe.

According to the present invention, the user begins by creating a list of searchable terms and saves the list as a search list in a data base. Next the user selects certain search results in terms of URLs, pages, and websites from the resulting search and saves them in a database as a list for recurring searches. As searches are done, the search results may be saved to refine the search list.

Those of ordinary skill in the art will understand that search resources will include any medium that can be digitized and may include chat rooms, blogs, forums, video, audio, news, images, etc.

When the user selects either the name of the search or the icon to activate the search, the user is prompted for and supplies the desired search terms. The search results come from the limited universe of searchable URLs, web pages, websites within the limited universe.

Over time the user is able, using the search terms, to perform an automatic update of the list of searchable materials that adds URLs, web pages and websites to the list of searchable sites depending on the search results obtained. If additional URLs, web pages and websites are found they may be added either automatically or manually to the universe of searchable information. If URLs, web pages, websites or other searchable material is found to be unreliable or untrustworthy such URL, webpage, website or other searchable material may be excluded from the universe of searchable material.

If others are allowed to share the effort of creating the focused searchable universe of the present invention, the creator of the universe may pass along rights to those sharing the ability to use the focused searchable universe to make additions or deletions to the content of the searchable universe.

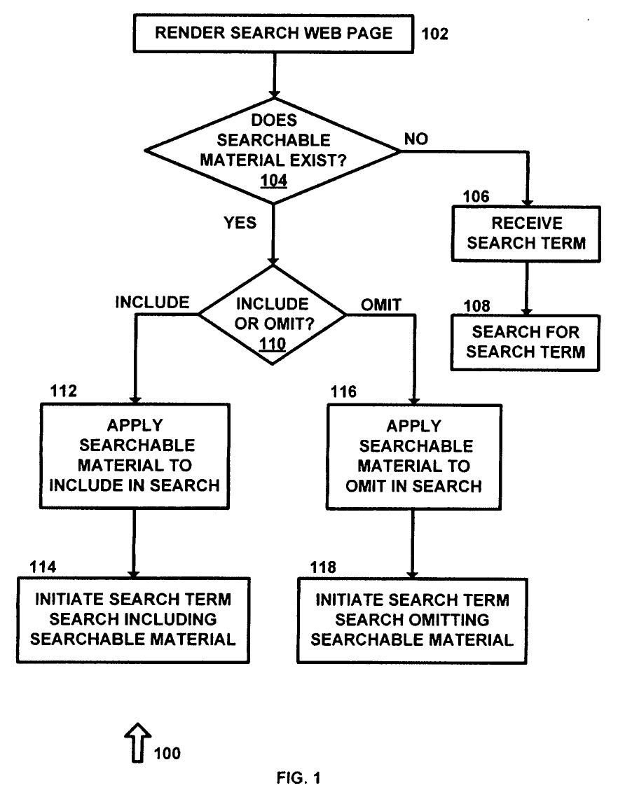

Referring to FIG. 1, there is shown at 100 a diagram of a method for focusing a web-based search, in accordance with an exemplary embodiment of the present invention. Method 100 can be implemented as an algorithm on a general purpose computing platform or other suitable systems.

The method begins at 102, where a search term is received from a user. In one exemplary embodiment, a web page with a textbox is rendered, wherein the user can enter a search text string comprised of alpha numeric characters into the textbox to search for content related to the search string. The method then proceeds to 104.

At 104, if searchable material exist, the method proceeds to 110. In one exemplary embodiment, searchable material exists on a web-enabled local host. In a second exemplary embodiment, the searchable material exists on a web-enabled server which serves the web page. In a third exemplary embodiment, the searchable material can be accessed on the server via a username and password. In a fourth exemplary embodiment, the searchable material can be located in a “cookie” resident on the local host. If searchable material does not exist, the method proceeds to 106.

At 106, the server receives the search string or search term. The method then proceeds to 108.

At 108, the server initiates a search using the received search string or term.

At 110, if a user has previously selected searchable material to include in a web-based search term search, the method proceeds to 112. In one exemplary embodiment the searchable material to include is isolated as the only searchable material to use in a web-based search term search. An icon can appear on the web page for the limited search universe, the user simply selects the icon and begins the search. The search results will be those obtained from only the limited search universe. If a user has previously selected searchable material to omit in a web-based search term search, the method proceeds to 112. In one exemplary embodiment, the searchable material to omit is isolated as the searchable material to exclude in a web-based search term search.

At 112, the searchable material to include in a search is applied to the web-based search term search. The method then proceeds to 114.

At 114, the search including the searchable material is initiated.

At 116, the searchable material to omit in a search is applied to the web-based search term search. The method then proceeds to 118.

At 118, the search omitting unreliable searchable material in a search is initiated.

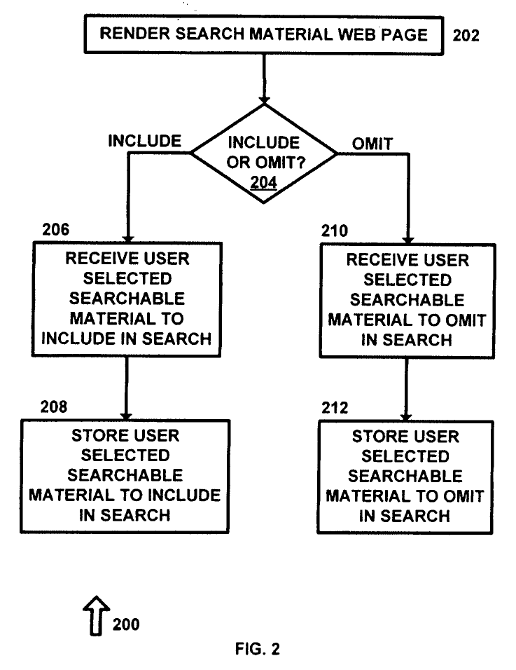

Referring now to FIG. 2, there is shown at 200 a diagram of a method for including or omitting searchable material, in accordance with an exemplary embodiment of the present invention. Method 200 can be implemented as an algorithm on a general purpose computing platform or other suitable systems.

The method begins at 202, where a web page listing all searchable material is rendered. In one exemplary embodiment, the web page is divided into two sections. The first section displaying the searchable material to include in a search, the second section displaying the searchable material to omit in a search. The method then proceeds to 204.

At 204, if a user wants to input searchable material to include in the search, the method proceeds to 206. If a user wants to input searchable material to omit in the search, the method proceeds to 210.

At 206, the searchable material to include in a search is received by either the client or the server. The method proceeds to 208.

At 208, the searchable material to include in a search is stored or persisted by either the client or the server. In one exemplary embodiment, the searchable material is stored in a “cookie,” other locally stored object of a browser, or other client-based storage. In a second exemplary embodiment, the searchable material is stored in a directory located on the server which is accessed with a username and password.

At 210, the searchable material to omit in a search is received by either the local host or the server. The method proceeds to 212.

At 212, the searchable material to omit in a search is stored or persisted by either the client or the server. In one exemplary embodiment, the searchable material is stored in a “cookie,” other locally stored object of a browser, or other client-based storage. In a second exemplary embodiment, the searchable material is stored in a directory located on the server which is accessed with a username and password.

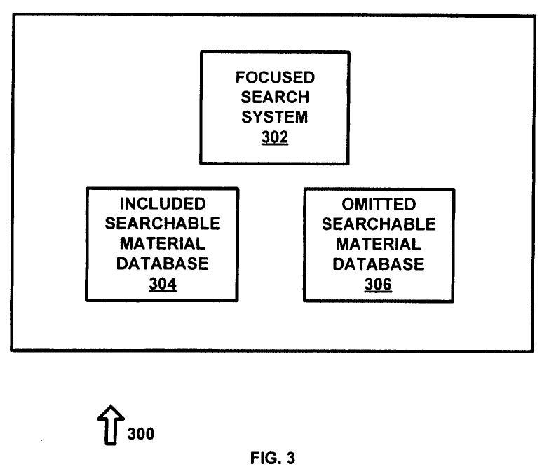

Referring now to FIG. 3, there is shown at 300 a diagram of a system for focusing a web-based search, in accordance with an exemplary embodiment of the present invention.

System 300 can be implemented in hardware, software or a suitable combination of hardware and software and can be one or more software systems operating on a digital signal processing platform or other suitable processing platforms. As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications or on two or more processors, or other suitable software structures. In one exemplary embodiment, software can include one or more lines of code or other suitable software structures operating in a general purpose software application, such as an operating system, and one or more lines of code or other suitable software structures operating in a specific purpose software application.

System 300 includes focused search system 302, included searchable material system 304, and omitted searchable material system 306. In one exemplary embodiment, focused search system 302 determines whether there is searchable material to include in a search and applies it to search parameters.

Included searchable material system 304 alters search results by ensuring that the searchable material indicated is included in the search. In one exemplary embodiment, a user can specify to isolate only the indicated searchable material on which to perform a search.

Omitted searchable material system 306 alters search results by ensuring that the searchable material indicated is omitted in the search. In one exemplary embodiment, a user can specify to omit specific directories of a website.

The present invention achieves further technical advantages by allowing a user to exercise greater control of their web-based search. Additionally, the control is robust enough to exclude either entire websites, or certain portions thereof.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. A focused web-based search system, comprising:
a search engine adapted to receive a search term and provide search results;
an included searchable material system adapted to receive searchable material and ensure that the searchable material is included in the search; and
a focused search system adapted to receive a search term and provide customized search results, by applying the included searchable material system and the omitted searchable material system.

2. The method of claim 1, further comprising an omitted searchable material system, as applied to the included searchable material system, adapted to receive searchable material and ensure that the searchable material is omitted from the included searchable material search.

3. The method of claim 1, wherein the included searchable material system is a database.

4. The method of claim 1, wherein the omitted searchable material system is a database.

5. A method for focusing a web-based search, comprising:
receiving searchable material;
determining whether there is searchable material to include or omit in a search term search;
applying searchable material to include in a search;
omitting unreliable searchable material in a search; and
initiating the search term search including the received searchable material.

6. The method of claim 5, wherein the searchable material is received from a “cookie,” other locally stored object of a browser, or other client-based storage.

7. The method of claim 5, wherein the searchable material is received from a server.

8. The method of claim 7, wherein the server is accessed using a username and password.

9. A method for including or omitting searchable material, comprising:
rendering a searchable material web page listing all searchable material;
displaying the searchable material to include in a first section;
displaying the searchable material to omit in a second section; and
providing a textbox in which to add searchable material.

10. The method of claim 9, further comprising storing or persisting the added searchable material.
